(19) United States
(12) Patent Application Publication
(10) Pub. No.: US 2012/0185463 A1
(43) Pub. Date: Jul. 19, 2012

(54) SYSTEM AND METHOD FOR MANAGING CONTENT DISPLAY INFORMATION

(75) Inventor: Woo-Hyeok Lim, Seoul (KR)

(73) Assignee: IGROVE, INC., Seoul (KR)

(21) Appl. No.: 13/119,923

(22) PCT Filed: Jul. 29, 2009
(86) PCT No.: PCT/KR09/04237

§ 371 Date: Mar. 30, 2012

(30) Foreign Application Priority Data
Sep. 22, 2008 (KR) 10-2008-0092870

(51) Int. Cl. G06F 17/30

(52) U.S. Cl. 707/722; 707/748; 707/E17.014

(57) ABSTRACT

A system for managing content display information by the disclosed present invention includes an interface module, a web-content search module, and a content display information tracking module. The interface module receives input information from a user, and the input information includes website information, content information and search parameter information which are tracking targets. The interface module transmits the user the tracking results of the content depending on the input information. The web-content search module searches content on a website based on the input information inputted from the interface module. The content display information tracking module tracks the display information on a screen that displays the results from the web content search module, wherein the display information includes: a page that displays content, and display priorities on a displayed page. Through the system, a user (contents provider) who registers products or goods for sale on an Internet shopping mall or an online marketplace is able to confirm the current display location of his/her registered content. That is to say, the user can easily judge the page number and the display priority of the content (displaying the ranking, the line number of the page) on the webpage that appears when a keyword corresponding to the content is inputted.

### CROSS-REFERENCES TO RELATED APPLICATIONS

This application is a U.S. national phase application, pursuant to 35 U.S.C. §371, of PCT/KR2009/004237, filed Jul. 29, 2009, designating the United States, which claims priority to Korean Application No. 10-2008-0092870, filed Sep. 22, 2008. The entire contents of the aforementioned patent applications are incorporated herein by this reference.

### TECHNICAL FIELD

The present invention relates, in general, to a system and method for managing content display information, and, more particularly, to a system and method that track the location where specific content is being displayed in a web page of search results when a user such as a specific content seller or provider searches for the specific content.

### BACKGROUND ART

Currently, with the development of computer technology and communication technology, the entire world has been rapidly connected over a single network, and the existing offline network has been replaced with an online network over such a network structure (the Internet).

One example of such a replacement is that selling or purchasing products in offline markets, for example, local markets, supermarkets, department stores or discount stores, over the existing offline network, has been performed together with or replaced with selling or purchasing products over an online network.

That is, networks have rapidly changed from offline networks over which a product purchaser must personally visit a market, a supermarket, a department store, or a discount store and purchase products while directly seeing a product seller in the prior art, to online networks over which a product purchaser purchases a required product while comfortably sitting down on a chair and viewing the screen of a computer.

However, since only the attributes of networks have changed and the basic attributes of the selling or purchasing (supply and demand) of products do not change, sellers (content providers) have conducted various types of marketing so as to realize differentiation from other sellers even in online markets, similarly to existing offline networks in which sellers intended to be differentiated from other sellers in such a way as to increase and put up their signboards or specify the exterior or interior designs of stores so that they can be desirably distinguished from the other sellers or the discrimination thereof can be improved.

A marketing method performed in such an online network, that is, a marketing method of arranging banner advertisements on the web screen of a portal site, an online shopping mall, or an online marketplace so as to be discriminated from other content providers, has been provided. However, there is a problem in that such a banner advertisement is merely shown, and it is impossible to objectively determine whether the banner advertisement has been actually displayed to visitors and to what extent the banner advertisement is effective.

A keyword search has been provided to replace the above-described marketing method and is configured such that a visitor (purchaser) enters a keyword related to his or her desired commodity or product (hereinafter referred to as ‘content’) on a portal site, an online shopping mall, or an online marketplace and such that when search results matching the entered keyword are displayed on a web page, the purchaser clicks an image of desired content while viewing the search results, thus making it possible to objectively determine whether the content has been displayed to the purchaser.

In more detail, when a commodity or product seller (hereinafter referred to as a ‘content provider’) registers content about what the seller desires to sell on an online shopping mall or an online marketplace, and designates a specific keyword so that the content can be searched for using the specific keyword in order to market the registered content, a commodity or product purchaser (hereinafter referred to as a ‘content purchaser’) visits the website of the online shopping mall or the online marketplace, and enters a keyword capable of indicating his or her desired content into a keyword search box, searches for content using the keyword, and determines whether to purchase the content while viewing search results on the screen.

In this case, the content purchaser typically and mainly views only the first page of the search result screen, and interest remarkably decreases in the remaining pages. Even for the same page, interest in pieces of content in the upper ranks is much higher than that in pieces of content in the lower ranks.

Due to these characteristics of the keyword search method, a content seller desires that his or her content be displayed in the upper ranks of search results so that the content seller is differentiated from other content providers, and then sets a plurality of keywords so that the relevant content can be frequently displayed by a keyword search. Further, the content seller needs to continuously enter keywords set thereby into a keyword search box and determine whether his or her content is displayed in the upper rank or is being gradually displayed in the upper rank.

Which of the plurality of keywords is being gradually displayed in smaller-numbered pages or in the upper ranks is determined, so that the purchasers' interest in keywords that are not effectively displayed decreases. Therefore, there is a need to increase the efficiency of management by intensively managing only keywords that are effectively displayed. When the content provider provides a plurality of pieces of content, there is a need to determine which of the pieces of content are displayed in the upper rank and are on an increasing sales trend.

However, the prior art is inconvenient in that, in order to manage keywords or content, a content provider must separately enter a plurality of keywords into a keyword search box and must visually and separately check the number of the page and the number of the rank on and in which content provided by the content provider is being displayed on the screen of search results while viewing the search result screen. Recently, the problem related to such an inconvenience has become so serious that it is impossible to manage pieces of content from the standpoint of the fact that content provided by each content provider has become diversified.

### Technical Problem

Accordingly, the present invention has been made keeping in mind the above problems occurring in the prior art, and an object of the present invention is to provide a system and method for managing content display information, in which a content provider can easily manage both keywords corresponding to content and the content in a portal site, an online shopping mall, or an online marketplace.

### Technical Solution

A system for managing content display information according to an embodiment of the present invention includes an interface module for receiving, from a user, input information that includes information about a website, content, and search conditions which are to be tracked, and transmitting results of tracking content based on the input information to the user; a web content search module for searching the website for the content based on the input information received from the interface module; and a content display information tracking module for tracking display information that includes a page or a rank on or in which the content is displayed on a screen of search results retrieved by the web content search module.

Accordingly, a user (content provider) who registers commodities or products on an online shopping mall or an online marketplace to sell the commodities or products can easily determine the current display location of content registered by the content provider, that is, the number of the page and the number of the rank (which may indicate line number of the page) on and in which the registered content is currently being displayed on the web page of search results when a keyword corresponding to the content is entered.

Preferably, the web content search module and the content display information tracking module may be operated at preset time periods.

Accordingly, the present invention can easily determine how effectively content has been managed or displayed on a web page on which search results matching a keyword corresponding to the content are sorted and shown by periodically tracking a page and a rank, on or in which the content is displayed, on a daily basis or some other time basis, or at preset periods.

Preferably, the system may further include a database module for storing the display information of the content tracked by the content display information tracking module.

Accordingly, since pieces of information about the previous display of the content (the pages or ranks on or in which the content was displayed) are periodically and sequentially stored, the present invention can easily manage the history of relevant content and can conduct aggressive marketing in relation to keywords for which display information is effectively obtained, that is, keywords for which content is displayed on a smaller-numbered page or in an upper rank. That is, for one piece of content, there may be a plurality of keywords or categories indicating the content, and among the keywords or categories, keywords for which the content can be displayed on a smaller-numbered page or in an upper rank can be easily determined and can be intensively managed.

Further, according to a predetermined embodiment of the present invention, the system may further include an information change determination module for determining a state in which the display information of the content changes at preset periods.

Accordingly, the present invention can determine whether the page or the rank on or in which relevant content is currently displayed has changed to a smaller-numbered page or an upper rank or to a larger-numbered page or a lower rank than the page or rank on or in which the relevant content was previously displayed, thus intensively concentrating marketing ability on a keyword or a category corresponding to content, the page or rank of which has changed to the smaller-numbered page or the upper rank. In contrast, when the page or the rank of relevant content has changed to the larger-numbered page or the lower rank, the competitive power of the content can be improved by changing a keyword or a category corresponding to the content, decreasing the price of the content, or conducting a promotion.

Preferably, the change state of the display information of the content, which has been determined by the information change determination module, may be output to the user via the interface module.

Accordingly, the present invention represents whether a page or a rank on or in which a keyword or a category corresponding to relevant content is displayed has changed to a smaller-numbered page or an upper rank or to a larger-numbered page or a lower rank in the form of a graph or a drawing, thus enabling the graph or the drawing to be provided as a tool that can be utilized by the user as strategic data.

Preferably, the search conditions may include a keyword search or a category search, and sorting of the search results by the web content search module may be selected from a set including a number of hits, a number of sales, a number of inquiries, and a number of consumer comments.

Furthermore, the present invention can immediately determine which of a plurality of keywords desired by a content provider, that is, a plurality of keywords corresponding to content, has been frequently hit or clicked (the strengthening of marketing for the relevant keyword), which of a plurality of pieces of content has been sold in large quantity (the strengthening of marketing for the relevant content), which of the pieces of content has received many inquiries from content purchasers (the reinforcement of an operational manual related to the content or the like), and which of the pieces of content has received many consumer comments (the analysis of consumers' needs related to the content and the determination of popularity).

In addition, a method of tracking content display information according to an embodiment of the present invention includes an information input step of receiving input information that includes information about a website, content and search conditions which are to be tracked; a content search step of searching the website for the content based on the input information received at the information input step; a display information tracking step of tracking display information that includes both a page on which the content is displayed on a screen of search results retrieved at the content search step, and a display rank of the content on the display page; and a display information display step of displaying the display information tracked at the display information tracking step.

Accordingly, a user (a content provider) who registers commodities or products on an online shopping mall or an online marketplace to sell the commodities or products can easily determine the current display location of content registered by the content provider, that is, the number of the page and the number of the rank (which may indicate a line number of the page) on and in which the registered content is currently being displayed on the web page of search results when a keyword corresponding to the content is entered.

Preferably, the content search step and the display information tracking step may be performed at preset periods.

Accordingly, the present invention can easily determine how effectively content has been managed or displayed on a web page on which search results matching a keyword corresponding to the content are sorted and shown by periodically tracking a page and a rank, on or in which the content is displayed, on a daily basis or some other time basis, or at preset periods.

Further, according to a preferred embodiment of the present invention, the method may further include a display information storage step of storing the display information tracked at the display information tracking step.

Accordingly, since pieces of information about the previous display of the content (the pages or ranks on or in which the content was displayed) are periodically and sequentially stored, the present invention can easily manage the history of relevant content and can intensively concentrate marketing ability on keywords or categories for which display information is effectively obtained, that is, keywords or categories for which the display of content has changed to upper rank. In contrast, when the page or the rank of relevant content has changed to a lower rank, the competitive power of the content can be improved by changing a keyword or a category corresponding to the content, decreasing the price of the content, or conducting a promotion.

Preferably, the method may further include a display information change determination step of determining a state in which the display information changes at preset periods.

Accordingly, the present invention can determine whether the page or the rank on or in which relevant content is currently displayed has changed to a smaller-numbered page or an upper rank or to a larger-numbered page or a lower rank than the page or rank on or in which the relevant content was previously displayed, and thus a keyword or a category corresponding to content, the page or rank of which has changed to the smaller-numbered page or the upper rank can be intensively used for marketing.

Preferably, the display information display step may be configured to display the change state of the display information determined at the display information change determination step.

Accordingly, the present invention represents whether a page or a rank on or in which a keyword or a category corresponding to relevant content is displayed has changed to a smaller-numbered page or an upper rank or to a larger-numbered page or a lower rank in the form of a graph or a drawing, thus allowing a user to intuitively determine such a change.

Preferably, the search conditions may include a keyword search or a category search, and a sorting method for search results, and the sorting method may be selected from a set including a number of hits, a number of sales, a number of inquiries, and a number of consumer comments.

Accordingly, the present invention can immediately determine which of a plurality of keywords desired by a content provider, that is, a plurality of keywords corresponding to content, has been frequently hit or clicked (the strengthening of marketing for the relevant keyword), which of a plurality of pieces of content has been sold in large quantity (the strengthening of marketing for the relevant content), which of the pieces of content has received many inquiries from content purchasers (the reinforcement of an operational manual related to the content or the like), and which of the pieces of content has received many consumer comments (the analysis of consumers' needs related to the content and the determination of popularity).

### Advantageous Effects

According to the above-described present invention, a content provider who sells commodities or products in an online shopping mall or an online marketplace can easily determine the current display location of content registered by the content provider, that is, the number of the page and the number of the rank (which may indicate a line number of the page) on and in which the registered content is currently being displayed on the web page of search results when a keyword corresponding to the content is entered.

Further, the present invention can easily determine how effectively content has been managed or displayed on a web page on which search results matching a keyword corresponding to the content are sorted and shown by periodically tracking a page and a rank, on or in which the content is displayed, on a monthly basis, a weekly basis, a daily basis, or some other time basis, or at preset periods.

Furthermore, since pieces of information about the previous display of the content (the pages or ranks on or in which the content was displayed) are periodically and sequentially stored, the present invention can easily manage the history of relevant content and can conduct aggressive marketing in relation to keywords for which display information is effectively obtained, that is, keywords for which content is displayed on a smaller-numbered page or in an upper rank.

Furthermore, for one piece of content, there may be a plurality of keywords or categories indicating the content, and among the keywords or categories, keywords for which the content can be displayed on a smaller-numbered page or in an upper rank can be easily determined and can be intensively managed.

Furthermore, whether the page or the rank on or in which relevant content is currently displayed has changed to a smaller-numbered page or an upper rank or to a larger-numbered page or a lower rank than the page or rank on or in which the relevant content was previously displayed can be determined, and thus marketing ability can be intensively concentrated on a keyword or a category corresponding to content, the page or rank of which has changed to the smaller-numbered page or the upper rank. In contrast, when the page or the rank of relevant content has changed to the larger-numbered page or the lower rank, the competitive power of the content can be improved by changing a keyword or a category corresponding to the content, decreasing the price of the content, or conducting a promotion.

Furthermore, whether a page or a rank on or in which a keyword or a category corresponding to relevant content is displayed has changed to a smaller-numbered page or an upper rank or to a larger-numbered page or a lower rank is represented in the form of a graph or a drawing, thus allowing a user to intuitively determine such a change.

Furthermore, the present invention can immediately determine which of a plurality of keywords desired by a content provider, that is, a plurality of keywords corresponding to content, has been frequently hit or clicked (the strengthening of marketing for the relevant keyword), which of a plurality of pieces of content has been sold in large quantity (the strengthening of marketing for the relevant content), which of the pieces of content has received many inquiries from content purchasers (the reinforcement of an operational manual related to the content or the like), and which of the pieces of content has received many consumer comments (the analysis of consumers' needs related to the content and the determination of popularity).

### DESCRIPTION OF DRAWINGS

FIG. 1 is a block diagram showing a system for managing content display information according to an embodiment of the present invention;

FIG. 2 is a block diagram showing a connection relationship between the content display information management system of FIG. 1 and other networks;

FIGS. 3 to 5 are diagrams showing the display information of content managed by the content display information management system of FIG. 1;

FIGS. 6 to 8 are diagrams showing the management of content by the content display information management system of FIG. 1; and

FIG. 9 is a flowchart showing a method of managing content display information according to an embodiment of the present invention.

### BEST MODE

Hereinafter, a system for managing content display information according to embodiments of the present invention will be described with reference to the attached drawings.

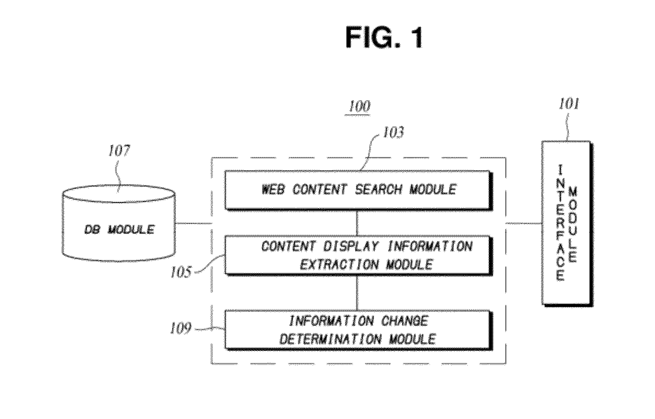

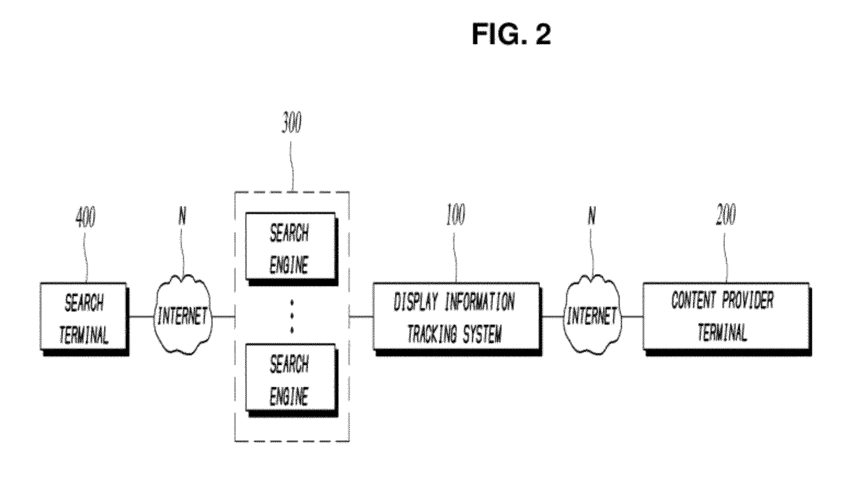

FIG. 1 is a block diagram schematically showing a system for managing content display information according to an embodiment of the present invention, and FIG. 2 is a block diagram showing the construction in which the content display information management system of FIG. 1 is connected to the Internet.

Referring to FIGS. 1 and 2, a system 100 for managing content display information according to an embodiment of the present invention includes an interface module 101, a web content search module 103, a content display information extraction module 105, and a database (DB) module 107.

The interface module 101 mediates between a content provider (user) who registers a commodity or a product on an online shopping mall, an online marketplace or a portal site and who desires to sell it, and the present system 100. The interface module 101 is configured such that when input information including information about content to be managed by the content provider, search conditions, and websites is input from a content provider terminal 200, the interface module 101 receives and processes the input information, and transmits display information processed by the content display information extraction module 105, which will be described later, to the content provider terminal 200.

In this case, the content information may include information indicating detailed features such as the name, trademark, size and color of a commodity or a product, and the search conditions may include keywords corresponding to content, or categories into which content can be classified. For example, content information such as a trademark, a small size, and a blue color for content ‘bag’ may be input, and a trademark, a book bag, a bag, a wallet, etc. may be input as a keyword. The domain name of the website of an online shopping mall or an online marketplace can be input as website information.

When the input information is received via the interface module 101, the web content search module 103 analyzes the website information of the input information, searches for the input information using the search engine 300 of a relevant website, and extracts relevant search results.

The content display information extraction module 105 extracts the display information of content corresponding to the input information from the search results extracted by the web content search module 103. In this case, information about the number of a display page and a display rank on and in which the content is being displayed on the web page of the search results may be extracted as the display information.

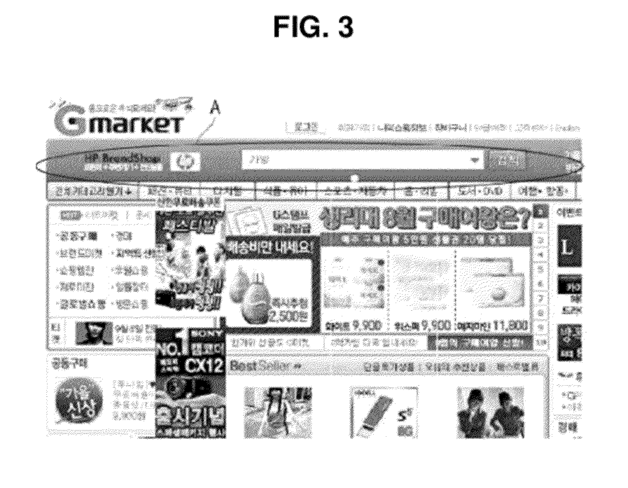

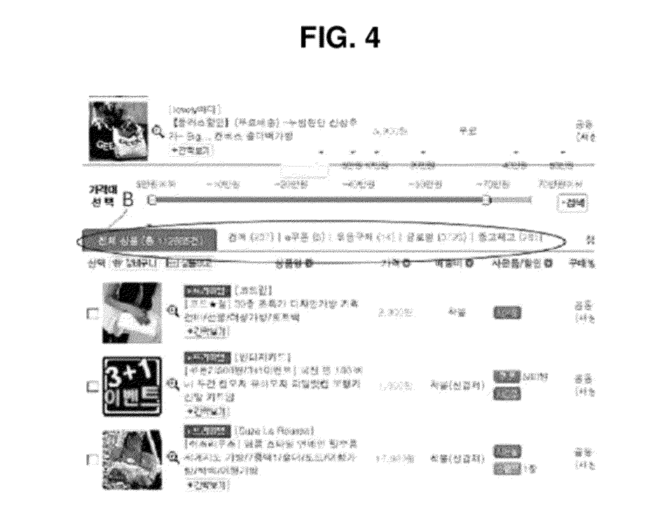

For example, when content desired to be sold by the content provider (a system user) is a bag, and ‘aa’ indicating the trademark ‘aa’ of the bag is entered as a keyword, a list of search results extracted by the search engine 300 of a specific online marketplace is extracted as the same information as that in a list of search results, obtained by a searcher entering a keyword (A of FIG. 3) into the keyword search box of the online marketplace using the search terminal 400 and searching for the relevant information. Pieces of content registered by other content providers may also be retrieved and included in the list of search results, and the screen of a plurality of search results is displayed, as shown in B of FIG. 4.

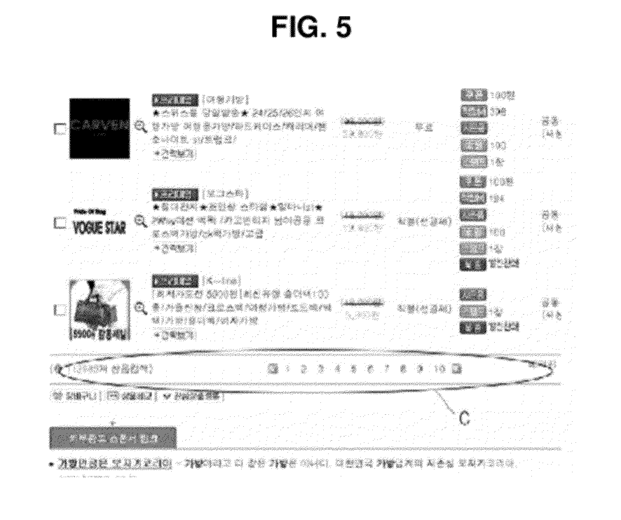

When, on the screen of a plurality of search results, content to be sold by the content provider (user) is displayed at, for example, page 5 (C of FIG. 5), the prior art causes inconvenience in that the content provider must personally memorize the page or must manually input and manage it and furthermore in that the content provider must individually check his or her content while manually going through the pages. In contrast, the present invention is configured such that when the keyword ‘aa’ is automatically entered, history indicating that it is being displayed at page 5 on a specific date and time is automatically managed.

Meanwhile, the history of the content can be managed using display pages, but can also be managed using all display ranks. That is, when the keyword ‘aa’ is entered, and a total of 100 search results are retrieved, the number of a rank in which the content registered by the content provider is displayed among the 100 search results can be managed.

In this way, the content provider can immediately determine the page or rank on or in which his or her content registered on the specific online marketplace is currently being displayed. Accordingly, even if the content provider registers a plurality of pieces of content, and a plurality of keywords corresponding to a plurality of pieces of content have been entered, display information can be easily managed.

Further, according to a preferred embodiment of the present invention, in order to manage such content, the display information of the content, and the history of the content display information, the web content search module 103 and the content display information extraction module 105 are periodically operated at preset time periods, and thus the display information is obtained from the search results. In this way, previous display information and current display information may be provided and be bases required to determine whether the display of relevant content has changed to the upper or lower rank.

For this operation, according to a predetermined embodiment of the present invention, the DB module 107 for storing the display information of the content is further included, and an information change determination module 109 for determining states in which the content display information changes at preset periods is included.

That is, the information change determination module 109 compares pieces of display information with one another at times t−T (period), t and t+T (period), and then determines whether the display page is changing to a smaller-numbered page or to a larger-numbered page and whether the display rank is changing to the upper or lower rank.

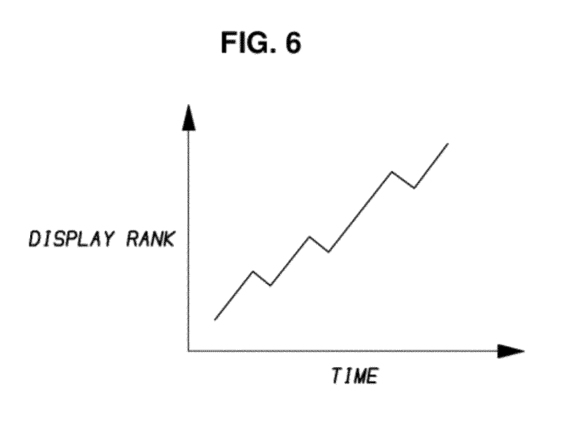

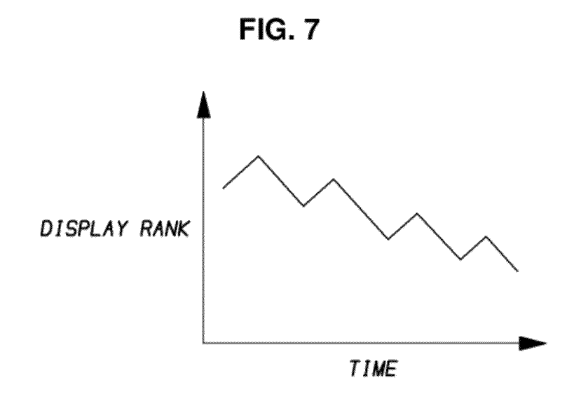

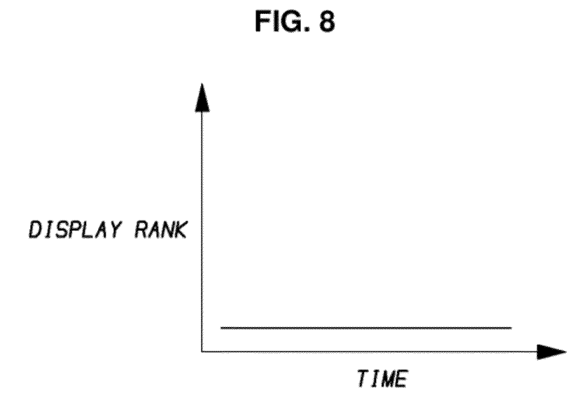

For example, in the case where if a keyword related to content ‘bag’ is set to ‘aa’, a display page (display rank) for the content ‘bag’ of the content provider retrieved using the keyword ‘aa’ is changing to an upper rank, as shown in FIG. 6, the case where if a keyword related to the same content ‘bag’ is set to ‘bb’, a display page (display rank) for the content ‘bag’ of the content provider retrieved using the keyword ‘bb’ is changing to a lower rank, as shown in FIG. 7, and the case where a display page (display rank) for the content ‘bag’ of the content provider is not changing in a lower rank, as shown in FIG. 8, the content provider can immediately determine that the keyword ‘aa’ needs to be further used when marketing.

Although only two keywords for a single piece of content have been used for the sake of example, the prior art makes it difficult to manage content and keywords when there are a larger number of pieces of content and a larger number of keywords corresponding to the content. However, the present invention can immediately determine the content and the keywords, so that if unnecessary keywords are deleted and only keywords on an increasing sales trend are intensively managed, the relevant content provider can gain a competitive advantage over other content providers.

Although a description has been made such that pieces of content and keywords corresponding thereto match one another in the description of the present invention, the same results may be obtained even if categories required to classify content instead of keywords match the content.

In this case, according to a preferred embodiment of the present invention, such change states are transmitted to the content provider terminal 200 via the interface module 101 so that they are displayed in the form of graphs, as shown in FIGS. 6 to 8, and are output to the content provider in order to allow such change states to be immediately recognized in a visual manner.

Meanwhile, the content display information extraction module 105 preferably inputs information about a sorting method to input conditions among pieces of the input information input by the content provider terminal 200. The sorting method may be implemented such that pieces of content are sorted based on the number of hits, the number of sales, the number of inquiries, or the number of consumer comments for the relevant content. Depending on each sorting method, even for the same keyword and the same content, a display page or a display rank can be varied, and the analysis of the results can also be varied.

For example, the number of hits denotes the number of times that content purchasers (purchase expectants) have clicked relevant content on the screen of the search results, and may be used to determine the popularity of the content. The number of sales denotes the number of times that the content was actually sold, and may be used to determine the popularity or the sales transition of the content. The number of inquiries denotes determining whether there have been many inquiries about the relevant content from content purchasers and may be used to take measures such as supplementing the operational manual of the relevant content and to provide standardized Q&A data. Further, the number of consumer comments denotes data obtained on the premise that the content was actually sold, and may be used to analyze the content purchasers' needs as well as the popularity of the content, thus enabling the analysis results to be used for marketing.

In this way, since the content provider can simply recognize content registered thereby on a specific website and the display information of the content, he or she can understand the marketing trends or trends related to specific content, thus enabling the selection of content that will be strategically supported in the future. For example, since the content ‘bag’ has an upper display rank, it exhibits a favorable transition in popularity or sales (FIG. 6), but when the content ‘book’ has an almost lower display rank (FIG. 7)(FIG. 8), it is profitable to strategically establish a sales strategy on the basis of the content ‘bag’. Accordingly, this profitableness is instantly and conveniently recognized by the relevant content provider, thus allowing the content provider to gain a competitive advantage over other content providers.

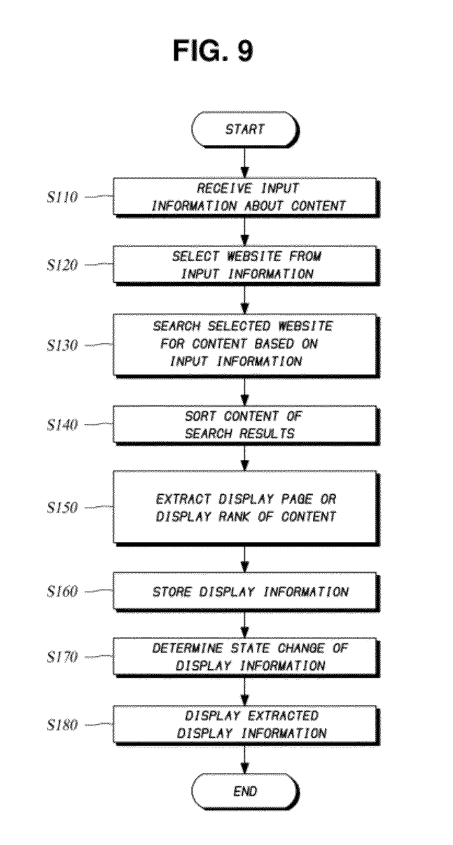

Meanwhile, FIG. 9 is a flowchart showing a method of extracting content display information according to a preferred embodiment of the present invention. Hereinafter, a method of tracking content display information according to an embodiment of the present invention will be described with reference to FIG. 5.

The content display information extraction method according to an embodiment of the present invention includes the information input step S110 of receiving input information about content, the content search step S120 of searching for content that matches the input information, the display information extraction step S150 of extracting the display information of the content from search results, and the display information display step S180 of displaying the extracted display information.

The information input step S110 is the step at which a user (a content provider) inputs information about content desired to be managed by the user using the content provider terminal 200, wherein the input information about the content includes information about the website of an online shopping mall or an online marketplace on which the content is intended to be sold, information about the content, and information about search conditions. The content information may include the name, trademark, color, size, etc. of a commodity or a product, and the search conditions may include settings related to whether a relevant search is a keyword search or a category search, and settings related to a sorting method. The sorting method may include sorting based on the number of hits, the number of sales, the number of inquiries, and the number of consumer comments for the content so that search results can be sorted. The display information of the content can vary according to the sorting method, and thus a marketing strategy can be established in the future in conformity with the sorting method.

Thereafter, information about a website is selected from the input information received at the information input step S110 at step S120, and content is searched for on the online shopping mall or the online marketplace corresponding to the selected website on the basis of the input information at step S120.

Search results are extracted using a keyword corresponding to the content information by the search engine 300 of the website selected at the content search step S120, and the extracted search results are sorted using the input sorting method at step S140, and the number of a page or the number of a rank on or in which the content of the content provider is displayed on the screen of the sorted search results is extracted at step S150.

Therefore, the extracted display information is provided to the content provider terminal 200, so that when the input information is received as the keyword ‘bag’ (A), as shown in FIG. 3, the content provider can instantly recognize that the results B entirely retrieved using the keyword ‘bag’ are provided, as shown in FIG. 4, and that his or her content is being displayed at page 5 (C), as shown in FIG. 5.

In accordance with a preferred embodiment of the present invention, a series of procedures is repetitively executed at regular periods, and includes the display information change determination step S170 of determining the state in which such display information changes at preset periods.

Therefore, it can be recognized where the content of the provider was previously displayed at, as well as where the content of the provider is currently being displayed at, so that how the display of the content is being performed can be determined. More preferably, the display information change state is displayed so that how the display information is being changed can be immediately recognized in a visual manner.

FIGS. 6 to 8 are diagrams briefly illustrating such display information change state, wherein it can be recognized in a visual manner whether relevant content is being gradually displayed in an upper rank, as shown in FIG. 6, whether the display of the relevant content is gradually changing to a lower rank, as shown in FIG. 7, and whether the display of the relevant content is not changing, as shown in FIG. 8, thus enabling a strategy for strengthening sales or marketing to be more aggressively or positively established for the content shown in FIG. 6.

In this case, the display information change state can be set such that it is determined on a monthly basis, a weekly basis, or some other time basis.

Furthermore, it is preferable to store the display information of the content extracted at the display information extraction step S150 so that the history of the content can be managed at step S160.

Although the preferred embodiments of the present invention have been shown and described, the present invention is not limited to those embodiments, and those skilled in the art will appreciate that various changes and modifications are possible without departing from the scope and spirit of the accompanying claims.

1. A system for managing content display information, comprising:
an interface module for receiving, from a user, input information that includes information about a website, content, and search conditions which are to be tracked, and transmitting results of tracking content based on the input information to the user;
a web content search module for searching the website for the content based on the input information received from the interface module; and
a content display information extraction module for extracting display information that includes a page or a rank on or in which the content is displayed on a screen of search results retrieved by the web content search module.

2. The system according to claim 1, wherein the web content search module and the content display information extraction module are operated at preset time periods.

3. The system according to claim 1, further comprising a database module for storing the display information of the content extracted by the content display information extraction module.

4. The system according to claim 3, further comprising an information change determination module for determining a state in which the display information of the content changes at preset periods.

5. The system according to claim 4, wherein the change state of the display information of the content, which has been determined by the information change determination module, is transmitted to the user via the interface module.

6. The system according to claim 2, further comprising a database module for storing the display information of the content extracted by the content display information extraction module.

7. The system according to any one of claims 1 to 6, wherein:
the search conditions include a keyword search or a category search, and
sorting of the search results by the web content search module is selected from a set including a number of hits, a number of sales, a number of inquiries, and a number of consumer comments.

8. A method of managing content display information, comprising:
an information input step of receiving input information that includes information about a website, content and search conditions which are to be tracked;
a content search step of searching the website for the content based on the input information received at the information input step;
a display information extraction step of extracting display information that includes both a page on which the content is displayed on a screen of search results retrieved at the content search step, and a display rank of the content on the display page; and
a display information display step of displaying the display information extracted at the display information extraction step.

9. The method according to claim 8, wherein the content search step and the display information extraction step are performed at preset periods.

10. The method according to claim 8, further comprising a display information storage step of storing the display information tracked at the display information extraction step.

11. The method according to claim 10, further comprising a display information change determination step of determining a state in which the display information changes at preset periods.

12. The method according to claim 11, wherein the display information display step is configured to display the change state of the display information determined at the display information change determination step.

13. The method according to claim 9, further comprising a display information storage step of storing the display information extracted at the display information extraction step.

14. The method according to any one of claims 8 to 13, wherein:
the search conditions include a keyword search or a category search, and a sorting method for search results, and
the sorting method is selected from a set including a number of hits, a number of sales, a number of inquiries, and a number of consumer comments.
